(19) United States
(12) Patent Application Publication
(10) Pub. No.: US 2026/0084824 A1
(43) Pub. Date: Mar. 26, 2026

(54) SERIES TURBINE SIMPLE CYCLE ECS

(71) Applicant: Hamilton Sundstrand Corporation, Charlotte, NC (US)

(72) Inventor: Mark G. Vignali, Simsbury, CT (US)

(21) Appl. No.: 19/334,711

(22) Filed: Sep. 19, 2025

Related U.S. Application Data
(60) Provisional application No. 63/697,158, filed on Sep. 20, 2024.

(51) Int. Cl. B64D 13/08; B64D 13/06

(52) U.S. Cl. CPC B64D 13/08; B64D 2013/0618; B64D 2013/0648

(57) ABSTRACT

An air conditioning system of a vehicle includes an inlet configured to receive a first medium and an outlet for delivering a conditioned form of the first medium to a load. A cooling circuit includes a heat exchanger fluidly connected to the inlet. A thermodynamic device includes a first turbine and a second turbine operably coupled by a shaft. Ann outlet of the first turbine is fluidly connected to an inlet of the second turbine. At least one turbine bypass conduit is fluidly connected to the cooling circuit. The at least one turbine bypass conduit is arranged to bypass at least one of the first turbine and the second turbine. A pressure of the first medium within the air conditioning system is greatest at the inlet.

### CROSS-REFERENCE TO RELATED APPLICATIONS

This application claims the benefit of priority to U.S. Provisional Application No. 63/697,158 filed September 20, 2024, the disclosure of which is incorporated herein by reference in its entirety.

### BACKGROUND

Embodiments of the disclosure relate to air conditioning system, and more specifically to an air conditioning systems (ACS) of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an air conditioning system of a vehicle includes an inlet configured to receive a first medium and an outlet for delivering a conditioned form of the first medium to a load. A cooling circuit includes a heat exchanger fluidly connected to the inlet. A thermodynamic device includes a first turbine and a second turbine operably coupled by a shaft. Ann outlet of the first turbine is fluidly connected to an inlet of the second turbine. At least one turbine bypass conduit is fluidly connected to the cooling circuit. The at least one turbine bypass conduit is arranged to bypass at least one of the first turbine and the second turbine. A pressure of the first medium within the air conditioning system is greatest at the inlet.

In addition to one or more of the features described herein, or as an alternative, in further embodiments the thermodynamic device does not include a compressor.

In addition to one or more of the features described herein, or as an alternative, in further embodiments the thermodynamic device includes a fan operably coupled to the shaft, wherein the fan is fluidly coupled to the cooling circuit and is operable to move a cooling medium through the cooling circuit.

In addition to one or more of the features described herein, or as an alternative, in further embodiments the cooling medium is ram air.

In addition to one or more of the features described herein, or as an alternative, in further embodiments a thrust recovery nozzle is fluidly connected to the cooling circuit. The thrust recovery nozzle is configured to generate thrust from the cooling medium.

In addition to one or more of the features described herein, or as an alternative, in further embodiments the thrust recovery nozzle is arranged downstream from the fan, and a pressure of the cooling medium upstream from the fan is less than a pressure of the cooling medium downstream from the fan.

In addition to one or more of the features described herein, or as an alternative, in further embodiments the at least one turbine bypass conduit includes a first turbine bypass conduit arranged in parallel with the first turbine.

In addition to one or more of the features described herein, or as an alternative, in further embodiments a water collector is arranged downstream from an outlet of the first turbine and upstream from an inlet of the second turbine relative to the flow of the first medium. The first turbine bypass conduit has a first turbine bypass outlet arranged directly downstream from the water collector.

In addition to one or more of the features described herein, or as an alternative, in further embodiments, the first turbine bypass conduit has a first turbine bypass outlet arranged directly upstream from the second turbine.

In addition to one or more of the features described herein, or as an alternative, in further embodiments the at least one turbine bypass conduit includes a second turbine bypass conduit arranged in parallel with the second turbine.

In addition to one or more of the features described herein, or as an alternative, in further embodiments at least one valve is operable to control a flow of the first medium provided to the at least one turbine bypass conduit based on a mode of the vehicle.

In addition to one or more of the features described herein, or as an alternative, in further embodiments the first medium is bleed air.

In addition to one or more of the features described herein, or as an alternative, in further embodiments a cooling circuit bypass conduit arranged in parallel with the heat exchanger.

In addition to one or more of the features described herein, or as an alternative, in further embodiments a valve operable to control a flow of the first medium provided to the cooling circuit bypass conduit.

According to an embodiment, a method of operating an air conditioning system of a vehicle includes during operation in a first mode, cooling a first medium via a cooling medium at a heat exchanger of a cooling circuit, drawing the cooling medium through the cooling circuit via a fan, pressurizing the cooling medium at the fan to form a pressurized cooling medium and extracting energy from the pressurized cooling medium. The fan is part of a thermodynamic device including a first turbine and a second turbine operably coupled to the fan by a shaft.

In addition to one or more of the features described herein, or as an alternative, in further embodiments the extracting energy from the pressurized cooling medium includes generating thrust.

In addition to one or more of the features described herein, or as an alternative, in further embodiments extracting energy from the first medium at the first turbine and the second turbine, the energy being used to drive the fan.

In addition to one or more of the features described herein, or as an alternative, in further embodiments removing moisture from the first medium downstream from the first turbine.

In addition to one or more of the features described herein, or as an alternative, in further embodiments in response to operation of the vehicle in a second mode, opening a valve associated with at least one turbine bypass conduit and directing the first medium to bypass at least one of the first turbine and the second turbine.

In addition to one or more of the features described herein, or as an alternative, in further embodiments the first medium is bleed air.

### BRIEF DESCRIPTION OF THE DRAWINGS

The following descriptions should not be considered limiting in any way. With reference to the accompanying figure, like elements are numbered alike:

FIG. 1 is a simplified schematic diagram of an air conditioning system of a vehicle according to an embodiment; and

FIG. 2 is a simplified schematic diagram of an air conditioning system of a vehicle according to another embodiment.

### DETAILED DESCRIPTION

A detailed description of one or more embodiments of the disclosed apparatus and method are presented herein by way of exemplification and not limitation with reference to the Figures.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the figure, an example of a schematic diagram of a portion of an environment control system, such as an air conditioning system or pack 20 for example, is depicted according to a non-limiting embodiment. Although the air conditioning system (ACS) or ACS pack 20 is described with reference to an aircraft, alternative applications, such as another vehicle for example, are also within the scope of the disclosure. As shown in the Figure, the ACS 20 can receive a first medium A1 at an inlet 22. In embodiments where the ACS 20 is used in an aircraft application, the first medium A1 may be bleed air, which is pressurized air originating from i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ACS 20 includes a cooling circuit 30 including at least one heat exchanger 32. Although not shown, it should be appreciated that in some embodiments, the cooling circuit 30 includes a duct or shell within which the at least one heat exchanger 32 is positioned. In such embodiments, the cooling shell can receive and direct a cooling medium through the cooling circuit 30. The one or more heat exchangers 32 are devices built for efficient heat transfer from one medium to another. Examples of the type of heat exchangers that may be used, include, but are not limited to, double pipe, shell and tube, plate, plate, plate and shell, adiabatic shell, plate fin, pillow plate, and fluid heat exchangers.

The one or more heat exchangers 32 may be referred to as cooling medium heat exchangers. In the illustrated, non-limiting embodiment, the cooling circuit 30 includes a single cooling medium heat exchanger 32. Within the heat exchanger 32, at least one cooling medium, such as outside air or ram air for example RA, acts as a heat sink to cool a medium passing there through, for example the first medium A1. Although a cooling circuit 30 having a single heat exchanger 32 is illustrated, it should be understood that embodiments having two or more heat exchangers are also contemplated herein. In embodiments where the cooling circuit 30 includes a plurality of heat exchangers, the plurality of heat exchangers may be arranged in series, may be arranged in parallel, or may be arranged some combination of series and parallel relative to a flow through the cooling circuit 30.

The ACS 20 additionally comprises at least one thermodynamic device 40. In the illustrated, non-limiting embodiments, the ACS 20 includes a single thermodynamic device 40. However, embodiments including two or more thermodynamic devices are also within the scope of the disclosure. In the illustrated, non-limiting embodiment, the thermodynamic device 40 of the ACS 20 is a mechanical device that includes components for performing thermodynamic work on a medium (e.g., extracts work from or applies work to the first medium A1 and/or the second medium A2 by raising and/or lowering pressure and by raising and/or lowering temperature). Examples of a thermodynamic device 40 include an air cycle machine, a two-wheel air cycle machine, a three-wheel air cycle machine, a four-wheel air cycle machine, etc.

As shown, the thermodynamic device 40 includes at least one turbine operably coupled to a shaft 42. In the illustrated, non-limiting embodiment, the thermodynamic device 40 includes a first turbine 44 and a second turbine 46. However, embodiments including a single turbine or more than two turbines are also within the scope of the disclosure. A turbine, such as turbines 44 and 46 for example, is a mechanical device that expands a medium and extracts work therefrom (also referred to as extracting energy). This extracted energy is transmitted to the shaft 42 and the other components operably coupled thereto. It should be appreciated that the thermodynamic device does not include a compressor. Accordingly, in an embodiment the pressure of the first medium does not increase within the ACS 20. The pressure of the first medium A1 may be greatest at the inlet 22.

In the illustrated, non-limiting embodiment, the thermodynamic device 40 includes a fan 48 operably coupled to the shaft 42. The fan 48 is a mechanical device that can force, via push or pull methods, a medium (e.g., ram air RA) across the one or more heat exchangers 32 and at a variable cooling flow rate to control temperatures. A fan 48 having any suitable flow configuration, such as an axial flow fan, a radial flow fan, and a mixed flow fan for example, are within the scope of the disclosure. It should be appreciated that in other embodiments, the fan 48 may be separate from the thermodynamic device 40 and driven by any suitable means. Examples of such a fan include an electrically driven fan, a tip turbine fan, or a fan that is part of a simple cycle machine.

The ACS 20 may additionally include at least one dehumidification system. The dehumidification system may be arranged in fluid communication with the medium A1. In the illustrated, non-limiting embodiment, the dehumidification system includes a water extractor or water collector 50. The water collector 50 is a mechanical device that performs a process of removing water from a medium. As shown, the water collector 50 may be arranged directly downstream from an outlet of a turbine, such as turbine 44 for example. In such embodiments, the turbine 44 is configured to function as a condenser because the temperature of the medium A1 within the turbine 44 is reduced as work is extracted therefrom. The turbine 44 and the water collector 50 in combination may be referred to herein as a “mid-pressure water separator.” In an embodiment, another water collector 52 may be arranged along the flow path of the medium A1, such as at a location directly downstream from the one or more cooling medium heat exchangers of the cooling circuit 30.

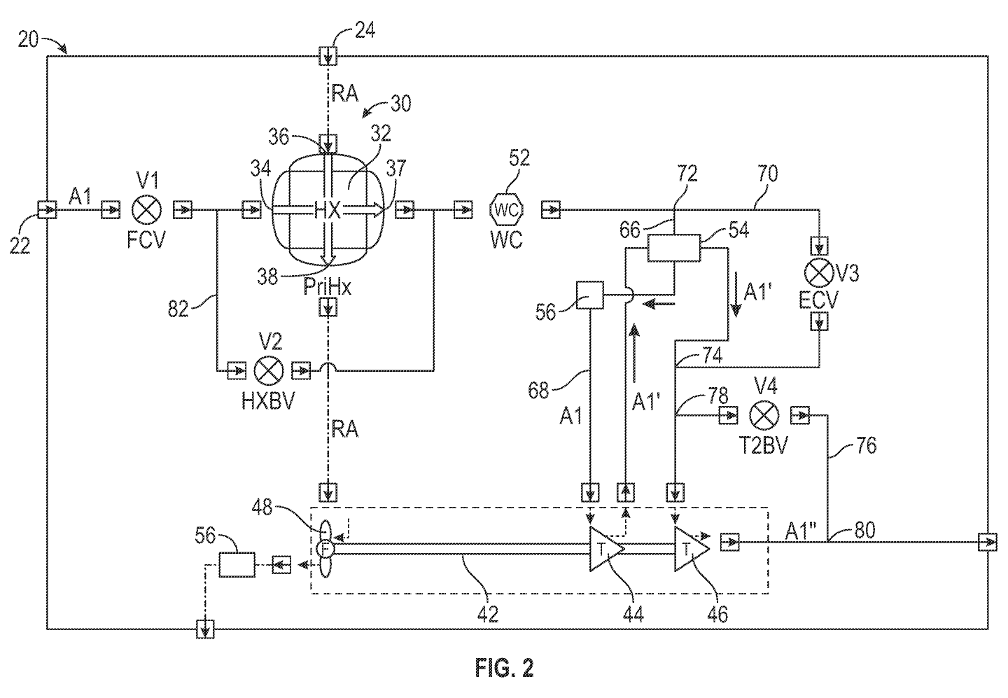

In other embodiments, such as shown in FIG. 2, the ACS 20 may include a high-pressure water separator, formed by a condensing heat exchanger 54 and a water collector 56 arranged in series, instead of the mid-pressure water separator. The first medium A1 is at its highest or greatest pressure within the ACS 20 when provided to the high-pressure water separator. In an embodiment, the first medium A1 remains at its highest pressure from the inlet 22 until reaching a turbine 44, 46 of the thermodynamic device 40.

The elements of the ACS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the ACS 20 can be regulated to a desired value. In an embodiment, the at least one valve of the ACS 20 includes a first flow control valve V1, operable to control the flow of the medium A1 provided to the ACS 20 via the inlet 22.

A second valve V2 may be operable to control a flow of the medium A1 through a cooling circuit bypass conduit 82. As shown, the cooling circuit bypass conduit 82 may extend in parallel with the cooling circuit 30, such as from a location directly upstream from the at least one cooling medium heat exchanger to a location directly downstream from the at least one cooling medium heat exchanger. The cooling circuit bypass conduit 82 may be used to increase the temperature of the first medium A1 provided at an outlet of the ACS 20 without bypassing the turbines 44, 46 of the ACM. In the illustrated, non-limiting embodiment, the cooing circuit bypass conduit 82 is arranged in parallel with the cooling medium heat exchanger 32. A third valve V3, also referred to herein as an economy cooling valve, may be operable to control a flow of the medium that bypasses the first turbine 44. Alternatively, or in addition, a fourth valve V4 may be operable to control a flow of the first medium A1 that bypasses both the second turbine 46. Although not shown, it should be appreciated that embodiments including another valve operable to control a flow of the first medium A1 to bypass both the first turbine and the second turbine, are within the scope of the disclosure.

The ACS 20 illustrated and described herein is operable in a plurality of modes, such as based on a condition of the vehicle. A first mode of the ACS 20 may be associated with operation of the vehicle on the ground. For example, the ACS 20 may be operable in a first mode when the aircraft is in a first flight state, such as during ground and low altitude flight conditions, for example ground idle, taxi, take-off, and hold conditions. During this first mode, valves V3 and V4 are closed. As shown, valve V1 is open such that the first medium A1, such as bleed air for example, received at the inlet 22 of the ACS 20 is provided to a first inlet 34 of the cooling medium heat exchanger 32 of the cooling circuit 30. A cooling medium RA received at an inlet 24 of the cooling circuit 30 is provided to a second inlet 36 of the heat exchanger 32. Within the cooling medium heat exchanger 32, the first medium A1 is cooled by the cooling medium RA.

The first medium A1 is provided at a first outlet 37 of the heat exchanger 32 and the cooling medium RA is provided at a second outlet 38 of the heat exchanger 32. The second outlet 38 of the heat exchanger 32 may be operably coupled to the fan 48 of the thermodynamic device 40. In the illustrated, non-limiting embodiment, the fan 48 is located downstream from the heat exchanger 32 such that the fan 48 is operable to draw the cooling medium RA through the cooling circuit 30, across the first heat exchanger 32, such as from the second inlet 36 to the second outlet 38. At a location downstream from the at least one heat exchanger 32 and the fan 48, the cooling medium RA may be exhausted overboard.

The first outlet 37 of the heat exchanger 32 may be fluidly connected to the inlet of the first turbine 44, such as via a first conduit 60 for example. In this first mode of operation, valve V3 is closed such that the first medium A1 output from the first outlet 37 of the heat exchanger 32 is provided directly to the first turbine 44 via the first conduit 60. Within the first turbine 44, the first medium A1 is expanded and work is extracted therefrom to form an expanded first medium A1’. This work may drive rotation of the shaft 42, and therefore the fan 48 coupled to the shaft 42, which moves the flow of the cooling medium RA through the cooling circuit 30 and may increase a pressure of the cooling medium RA at the fan 48.

As shown, the outlet of the first turbine 44 is fluidly connected to the and the inlet of the second turbine 46 via at least one conduit 62, 64. Accordingly, the first turbine 44 and the second turbine 46 may be arranged in series relative to a flow of the first medium A1. In an embodiment, second conduit 62 extends between and fluidly couples the outlet of the turbine 44 to an inlet of the water collector 50 such that the water collector 50 is arranged directly downstream from the outlet of the first turbine 44. Within the first turbine 44, the first medium A1 is cooled, causing moisture therein, such as water for example, to condense. The resulting expanded first medium A1’ containing condensed moisture is delivered from the outlet of the first turbine 44 to the water collector 50. Within the water collector 50, free moisture is removed from the expanded first medium A1’.

The third conduit 64 fluidly connects an outlet of the water collector 50 and an inlet of the second turbine 46. In an embodiment, the dehumidified expanded first medium A1’ is provided from the water collector 50 directly to an inlet of the second turbine 46. Energy is extracted from the expanded first medium A1’ within the second turbine 46 to drive the fan 48 via the shaft 42. The resulting further expanded first medium A1” output from the outlet of the second turbine 46 may be delivered to an outlet 25 of the ACS 20, and from the outlet 25 to one or more loads 26 of the aircraft, such as the cabin for example.

In an embodiment, the fan 48 is operable to increase the pressure of the cooling medium RA as it passes therethrough, thereby forming a pressurized cooling medium. In such embodiments, energy may be extracted from the pressurized cooling medium RA. As shown, a thrust recovery nozzle 58 may be located downstream from and fluidly connected to the fan 48. In such embodiments, the cooling medium RA output from the thrust recovery nozzle 58 may be exhausted overboard, or alternatively, may provided to another system of the aircraft. Movement of the cooling medium RA through the thrust recovery nozzle 58 may generate thrust used by the aircraft. The thrust generated by the pressurized cooling medium RA at the thrust recovery nozzle 58 may be sufficient to offset the drag generated by the cooling medium RA. The thrust recovery nozzle 58 may be a fixed area nozzle, or in other embodiments, may be a variable area nozzle. In embodiments where the thrust recovery nozzle 58 is a variable area nozzle, the nozzle may be adjustable based on how much cooling medium RA is required. A variable area nozzle may also be controlled to protect the fan 48 against overheating or surging.

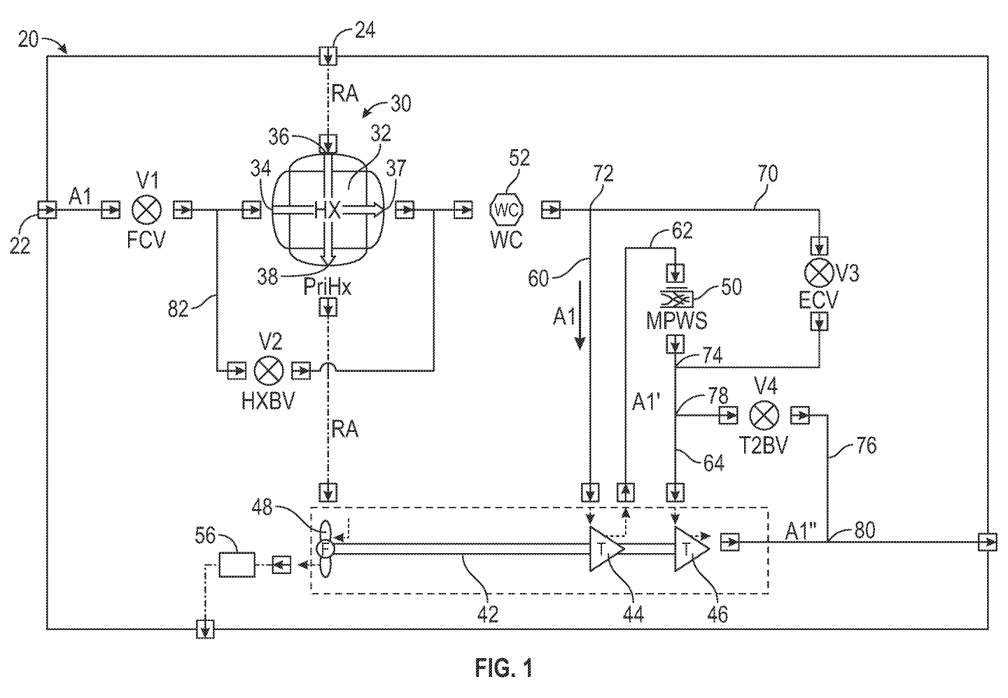

Operation of the ACS 20 illustrated in FIG. 2 in a first, ground or low-altitude mode is substantially identical to operation of the ACS 20 of FIG. 1. However, in the ACS 20 of FIG. 2, the flow of the first medium A1 provided at the first outlet 37 of the heat exchanger 32 passes through the water collector 52, and is then provided to the downstream condensing heat exchanger 54 via a conduit 66. Within the condensing heat exchanger 54, the first medium A1 is cooled by a flow of expanded first medium A1’ output from the first turbine 44. As the first medium A1 is cooled within the condensing heat exchanger 54, moisture within the first medium A1 is condensed. The first medium A1 then enters a water collector 56 where any free moisture in the first medium A1 is removed. This cool, dry, first medium A1 output from the high-pressure water separator is then delivered to an inlet of the first turbine 44 via a conduit 68.

With the first turbine 44, the first medium A1 is expanded and work is extracted therefrom to form an expanded first medium A1’. The expanded first medium A1’ output from the turbine 44 is provided to a second pass of the condensing heat exchanger 54 and acts as a heat sink within the condensing heat exchanger 54 to absorb heat from the first medium A1 output from the heat exchanger 32. The heated expanded first medium A1’ output from the condensing heat exchanger 54 is then provided to an inlet of the second turbine 46 so that energy may be extracted from the expanded first medium A1’ therein to form a further expanded first medium A1” as previously described.

The ACS 20 may also be operable in a second mode. The second mode may be associated with a second flight state, such as “high-altitude” operation suitable for use during flight conditions such as at high altitude cruise, climb, and descent flight conditions. In the second mode of operation, at least one of the first valve V3 and the second valve V4 is open.

Operation of the ACS 20 of both FIG. 1 and FIG. 2 in a second mode, such as associated with high-altitude cruise for example, may be similar to operation on the ground. In an embodiment, the flow of the cooling medium RA through the cooling circuit 30 is identical in each of the plurality of modes of operation. Both the first medium A1 and the cooling medium RA are provided to the heat exchanger 32 of the cooling circuit 30 as previously described. The first medium A1 is cooled by the cooling medium RA within the heat exchanger 32. The cooling medium RA, which acts as a heat sink by absorbing heat from the first medium A1, is moved from the second outlet 38 of the heat exchanger 32, through the cooling circuit 30 by the fan 48. Energy may be extracted from the cooling medium RA output from the cooling circuit 30 via the thrust recovery nozzle 58.

With reference again to FIG. 1, as previously noted, the first outlet 37 of the heat exchanger 32 is fluidly connected to the inlet of the first turbine 44 via the first conduit 60. A first turbine bypass conduit 70 has a first turbine bypass inlet 72 fluidly connected to the first conduit 60 at a location downstream from the first outlet 37 and from the water collector 52, and upstream from the inlet of the first turbine 44. Further, a first turbine bypass outlet 74 of the first turbine bypass conduit 70 is fluidly connected to the third conduit 64 at a location downstream from the water collector 50 and upstream from the inlet of the second turbine 46. Accordingly, the first turbine bypass conduit 70 is arranged in parallel with the first turbine 44. The third valve V3 may be arranged at and is operable to control a flow of the first medium A1 from the water collector 52 to the first turbine bypass conduit 70.

Similarly, a second turbine bypass conduit 76 is arranged in parallel with the second turbine 46. The second turbine bypass conduit 76 has a second turbine bypass inlet 78 fluidly connected to the third conduit 64 location downstream from the outlet of the water collector 50 and from the first turbine bypass outlet 74, and upstream from the inlet of the second turbine 46. A second turbine bypass outlet 80 of the second turbine bypass conduit 76 may be fluidly connected to the outlet of the second turbine 46, such as at a location downstream from the second turbine 46. The second turbine bypass conduit 76 is therefore arranged in parallel with and configured to bypass the second turbine 46. The fourth valve V4 may be arranged at and is operable to control a flow of the first medium A1 from the heat exchanger 32 to the second turbine bypass conduit 76.

In embodiments where the first valve V3 is open, the first medium A1 at the first outlet 37 of the heat exchanger 32 flows through the water collector 52 where moisture is removed from the first medium A1. The first medium A1 then flows through the first turbine bypass conduit 70 such that the first medium A1 bypasses the first turbine 44 and the water collector 50. From the first turbine bypass conduit 70, the first medium A1 may be delivered to the inlet of the second turbine 46 via the third conduit 64. Energy is extracted from the first medium A1 within the second turbine 46 to drive the fan 48 via the shaft 42. The resulting expanded first medium A1” output from the outlet of the second turbine 46 may be delivered to one or more loads 26 of the aircraft, such as the cabin for example.

In embodiments where the first valve V3 is closed and the second valve V4 is open, the first medium A1 at the first outlet 37 of the heat exchanger 32 flows through the second turbine bypass conduit 76, thereby bypassing the first turbine 44, the water collector 50, and the second turbine 46. The first medium A1 provided at the outlet 80 of the second turbine bypass conduit 76 may be directly delivered to one or more loads 26 of the aircraft, such as the cabin for example. By opening the valve V3, the pressure drop associated with the first turbine 44 and the water collector 50 is avoided when the aircraft is at altitude and very little moisture is present within the first medium. Further, this reduced pressure drop increases the flow of the first medium A1 provided to the second turbine 46, thereby maximizing the power available to drive the fan 48 and generate thrust via the thrust recovery nozzle 58.

With reference now to FIG. 2, operation of the ACS 20 in a second, high-altitude mode, is similar to operation of the ACS 20 of FIG. 1 in the second, high-altitude mode. The ACS 20 of FIG. 2 includes a first turbine bypass conduit 70 having an inlet 72 fluidly connected to the conduit 66 upstream from the condensing heat exchanger 54 and an outlet location downstream from the second pass through the condensing heat exchanger 54. Accordingly, the first turbine bypass conduit 70 is arranged in parallel with and therefore bypasses the first pass through the condensing heat exchanger 54, the water collector 56, the first turbine 44, and the second pass through the condensing heat exchanger 54.

Similarly, a second turbine bypass conduit 76 is fluidly connected to the conduit 81 extending between and fluidly connected the outlet of the second pass o the condensing heat exchanger. The inlet 78 of the second turbine bypass conduit 76 may be located downstream from the outlet 74 of the first turbine bypass conduit 70 and upstream from the inlet of the second turbine 46. The outlet 80 of the second turbine bypass conduit 76 may be fluidly connected to a conduit extending from an outlet of the second turbine 46, at a location downstream from the second turbine 46. The second turbine bypass conduit 76 is therefore configured to bypass the second turbine 46.

In embodiments where the third valve V3 associated with the first turbine bypass conduit is open and the fourth valve V4 associated with the second turbine bypass conduit 76 is closed, the first medium A1 at the first outlet 37 of the heat exchanger 32 flows through the water collector 52, and through the first turbine bypass conduit 70 to conduit 81. Within the conduit 81, the first medium A1 is then provided directly to the inlet of the second turbine 46. Energy is extracted from the first medium A1 within the second turbine 46 to drive the fan 48 via the shaft 42. The resulting expanded first medium A1” output from the outlet of the second turbine 46 may be delivered to one or more loads 26 of the aircraft, such as the cabin for example.

Aspects of the embodiments are described herein with reference to flowchart illustrations, schematics, and/or block diagrams of methods, apparatus, and/or systems according to embodiments. Further, the descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the preferred embodiment has been described, it will be understood that those skilled in the art, both now and in the future, may make various improvements and enhancements which fall within the scope of the claims which follow. These claims should be construed to maintain the proper protection.

What is claimed is:

1. An air conditioning system of a vehicle, the air conditioning system comprising:
an inlet configured to receive a first medium;
an outlet for delivering a conditioned form of the first medium to a load;
a cooling circuit including a heat exchanger, the heat exchanger being fluidly connected to the inlet;
a thermodynamic device including a first turbine and a second turbine operably coupled by a shaft, an outlet of the first turbine being fluidly connected to an inlet of the second turbine;
at least one turbine bypass conduit fluidly connected to the cooling circuit, the at least one turbine bypass conduit being arranged to bypass at least one of the first turbine and the second turbine; and
wherein a pressure of the first medium within the air conditioning system is greatest at the inlet.

2. The air conditioning system of claim 1, wherein the thermodynamic device does not include a compressor.

3. The air conditioning system of claim 1, wherein the thermodynamic device includes a fan operably coupled to the shaft, wherein the fan is fluidly coupled to the cooling circuit and is operable to move a cooling medium through the cooling circuit.

4. The air conditioning system of claim 3, wherein the cooling medium is ram air.

5. The air conditioning system of claim 3, further comprising a thrust recovery nozzle fluidly connected to the cooling circuit wherein the thrust recovery nozzle is configured to generate thrust from the cooling medium.

6. The air conditioning system of claim 5, wherein the thrust recovery nozzle is arranged downstream from the fan, and a pressure of the cooling medium upstream from the fan is less than a pressure of the cooling medium downstream from the fan.

7. The air conditioning system of claim 1, wherein the at least one turbine bypass conduit includes a first turbine bypass conduit arranged in parallel with the first turbine.

8. The air conditioning system of claim 7, further comprising a water collector arranged downstream from an outlet of the first turbine and upstream from an inlet of the second turbine relative to the flow of the first medium, the first turbine bypass conduit having a first turbine bypass outlet arranged directly downstream from the water collector.

9. The air conditioning system of claim 7, wherein the first turbine bypass conduit having a first turbine bypass outlet arranged directly upstream from the second turbine.

10. The air conditioning system of claim 7, wherein the at least one turbine bypass conduit includes a second turbine bypass conduit arranged in parallel with the second turbine.

11. The air conditioning system of claim 1, further comprising at least one valve operable to control a flow of the first medium provided to the at least one turbine bypass conduit based on a mode of the vehicle.

12. The air conditioning system of claim 1, wherein the first medium is bleed air.

13. The air conditioning system of claim 1, further comprising a cooling circuit bypass conduit arranged in parallel with the heat exchanger.

14. The air conditioning system of claim 13, further comprising a valve operable to control a flow of the first medium provided to the cooling circuit bypass conduit.

15. A method of operating an air conditioning system of a vehicle, the method comprising:
during operation in a first mode, cooling a first medium via a cooling medium at a heat exchanger of a cooling circuit;
drawing the cooling medium through the cooling circuit via a fan, wherein the fan is part of a thermodynamic device including a first turbine and a second turbine operably coupled to the fan by a shaft;
pressurizing the cooling medium at the fan to form a pressurized cooling medium; and
extracting energy from the pressurized cooling medium.

16. The method of claim 15, wherein the extracting energy from the pressurized cooling medium includes generating thrust.

17. The method of claim 15, further comprising extracting energy from the first medium at the first turbine and the second turbine, the energy being used to drive the fan.

18. The air conditioning system of claim 15, further comprising removing moisture from the first medium downstream from the first turbine.

19. The air conditioning system of claim 15, further comprising:
in response to operation of the vehicle in a second mode, opening a valve associated with at least one turbine bypass conduit; and
directing the first medium to bypass at least one of the first turbine and the second turbine.

20. The air conditioning system of claim 15, wherein the first medium is bleed air.
